(19) United States
(12) Patent Application Publication
(10) Pub. No.: US 2021/0031348 A1
(43) Pub. Date: Feb. 4, 2021

(54) FASTENER DRIVING MACHINE

(71) Applicant: KOKI HOLDINGS CO., LTD., Tokyo (JP)

(72) Inventors: Kenji KOBORI, Ibaraki (JP); Shinichirou SATO, Ibaraki (JP); Takashi UEDA, Ibaraki (JP)

(21) Appl. No.: 17/074,145

(22) Filed: Oct. 19, 2020

Related U.S. Application Data
(63) Continuation of application No. 15/570,737, filed on Oct. 30, 2017, now Pat. No. 10,843,318.

(30) Foreign Application Priority Data
Apr. 30, 2015 (JP) 2015-093512

(51) Int. Cl. B25C 1/04; B25C 1/06

(52) U.S. Cl. CPC B25C 1/047; B25C 1/001; B25C 1/06

(57) ABSTRACT

In order to make it possible to easily carry out filling up of a compressed air to a compression chamber without making a fastener driving machine larger in size, there is provided a fastener driving machine that includes a cylinder that forms a piston chamber defined by a piston and drives a driver blade by the piston. The housing has a cylinder case part for housing a cylinder, and a handle part. A pressure accumulating container is provided on the cylinder. The pressure accumulating container includes a bottom wall portion and a top wall portion. A compression chamber that communicates with the piston chamber is provided therein.

### CROSS REFERENCES

This is a Continuation of U.S. patent application Ser. No. 15/570,737, filed on Oct. 30, 2017. Which is the U.S. National Phase under 35 U.S.C. § 371 of International Application No. PCT/JP2016/060935, filed on Apr. 1, 2016, which claims the benefit of Japanese Application No. 2015-093512, filed on Apr. 30, 2015, the entire contents of each are hereby incorporated by reference.

### TECHNICAL FIELD

The present invention relates to a fastener driving machine for driving a fastener, such as a nail and a staple to a member into be driven.

### BACKGROUND ART

A fastener driving machine for driving a fastener such as a nail into a member to be driven such as lumber has a driver blade that strikes the fastener from an injection port of the fastener driving machine. In a fastener driving machine using a compressed air as a driving source of a driver blade, the driver blade is driven by a piston. When the driver blade is driven, a fastener is driven into a member to be driven by means of the driver blade. The fastener driving machine has a magazine that houses a large number of fasteners, and the fasteners are fed from the magazine to the front of the driver blade. Patent Document 1 discloses a fastener driving machine provided with a piston. The piston has a cylindrical part and an end wall part, and is assembled in a cylinder so that the piston can freely reciprocate.

Patent Document 1 discloses a fastener driving machine in which bellows stretchable in an axial direction thereof is assembled in a cylinder. A compressed air is sealed in the bellows. In this type of fastener driving machine, one end portion of the bellows is fixed at an end wall part of a piston, and the other end portion thereof is fixed to a housing provided at a top part side of the cylinder. Patent Document 1 further discloses a fastener driving machine in which a pressure accumulating chamber is formed by a piston and a cylinder. In this type of fastener driving machine, a flange is provided at an open end of the piston, and the flange is in sliding contact with an inner circumferential surface of the cylinder. In order to cause the piston to move backward in a contraction direction thereof against thrust applied to the piston in a direction to be struck by the bellows and the compressed air in the pressure accumulating chamber, a cam rotationally driven by a motor engages with the piston.

### RELATED ART DOCUMENTS

### Patent Documents

Patent Document 1: Japanese Patent Application Publication No. 2014-69289

### SUMMARY OF THE INVENTION

### Problems to be Solved by the Invention

This type of fastener driving machine in which the bellows is assembled in the inside of the cylinder has a double structure in which a striking portion for a driver blade is composed of a bellows and a cylinder. The type of fastener driving machine in which a pressure accumulating chamber is defined by the piston and the cylinder has a double structure in which the striking portion is composed of the piston and the cylinder. The fastener driving machine with such a double structure has a complex structure. Further, in the fastener driving machine in which the pressure accumulating chamber inside the bellows is caused to expand and contract in an axial direction thereof or the pressure accumulating chamber is caused to expand and contract by means of the piston and the cylinder, in order to ensure a volume of the pressure accumulating chamber, a dimension of the fastener driving machine in a driving direction, that is, a vertical dimension thereof has to be made longer. For this reason, the vertical dimension of the fastener driving machine becomes larger.

In the fastener driving machine in which the pressure accumulating chamber is formed by the piston and the cylinder, a filling valve is assembled at an end wall part of the cylinder of a top part side in order to fill the inside of the pressure accumulating chamber with a compressed gas. The end wall part is assembled inside the housing. In a case where the filling valve is assembled at the end wall part, a length of the cylinder including the end wall part becomes longer, and a vertical dimension of the fastener driving machine thus becomes larger. Further, in a case where the filling valve is provided at the end wall part, it is impossible to easily carry out a filling operation of the compressed gas by using the filling valve.

It is an object of the present invention to make it possible to easily carry out filling up of a compressed air to a compression chamber without making a fastener driving machine larger in size.

### Means for Solving the Problems

A fastener driving machine according to the present invention is a fastener driving machine provided with a cylinder in which a piston is allowed to freely reciprocate, the cylinder forming a piston chamber defined by the piston, the fastener driving machine being configured to drive a driver blade to drive a fastener to a member to be driven by means of the piston, the fastener driving machine including: a housing provided with a cylinder case part and a handle part, the cylinder case part housing the cylinder, the handle part being continued to the cylinder case part; a bottom wall portion extending outward from the cylinder; a top wall portion that faces the cylinder and the bottom wall portion; a pressure accumulating container configured to form a compression chamber that communicates with the piston chamber; and a filling valve provided on the bottom wall portion to fill the compression chamber with a gas.

### Advantageous Effects of the Invention

The pressure accumulating container that forms the compression chamber communicated with the cylinder chamber has the bottom wall portion extending outward in a radial direction of the cylinder. The filling valve for filling the compression chamber with a gas is provided in a space between the cylinder and the cylinder case part. This makes it possible to dispose the filling valve in the housing by using the space between the cylinder and the cylinder case part. It is possible to easily carry out filling up of a compressed air to the compression chamber without making the fastener driving machine larger in size.

### BRIEF DESCRIPTIONS OF THE DRAWINGS

FIG. 1 is a sectional view of a fastener driving machine according to one embodiment when viewed from a side surface thereof, and shows a state where a driver blade projects.

FIG. 2 is a plan view of FIG. 1.

FIG. 3 is a sectional view taken along an A-A line of FIG. 1.

FIG. 4 is a sectional view showing a state where the driver blade is moved backward.

FIG. 5 is a sectional view taken along a B-B line of FIG. 1.

FIG. 6 is a partial cutaway front view of a fastener driving machine according to a modified example.

FIG. 7 is a partial cutaway back view of a fastener driving machine according to another modified example when viewed from a magazine side.

FIG. 8 is a partial cutaway back view of a fastener driving machine according to still another modified example when viewed from a magazine side.

FIG. 9 is a partial cutaway back view of a fastener driving machine according to still another modified example when viewed from a magazine side.

FIG. 10 is a sectional view taken along a C-C line of FIG. 9.

FIG. 11 is a side view of the fastener driving machine in which a lid member provided in a housing is shown.

FIG. 12 is a side view showing a part of the fastener driving machine in which a lid member according to a modified example is provided.

FIG. 13 is a sectional view of a side surface showing a main part of a fastener driving machine according to another embodiment.

FIG. 14 is an enlarged sectional view showing a pressure accumulating container shown in FIG. 13.

FIG. 15 is a sectional view taken along a D-D line of FIG. 13.

FIG. 16 is a sectional view taken along an E-E line of FIG. 13.

FIG. 17(A) is a plan view showing another modified example of the pressure accumulating container shown in FIG. 13, and FIG. 17(B) is a sectional view taken along an F-F line of FIG. 17(A).

FIG. 18(A) is a plan view showing still another modified example of the pressure accumulating container shown in FIG. 13, and FIG. 18(B) is a sectional view taken along a G-G line of FIG. 18(A).

### DESCRIPTIONS OF THE EMBODIMENTS

Hereinafter, embodiments of the present invention will be described in detail on the basis of the drawings. In each of the drawings, the same reference numerals are assigned to common members, respectively.

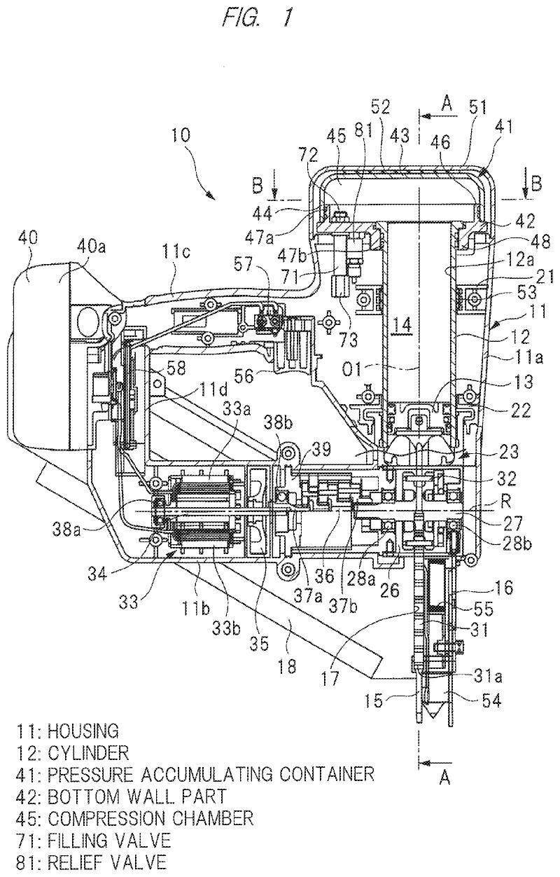

A fastener driving machine 10 shown in FIG. 1 to FIG. 5 has a housing 11. The housing 11 includes a cylinder case part 11a and a motor case part 11b. The cylinder case part 11a houses a cylinder 12. The motor case part 11b is integrated with a tip part of the cylinder case part 11a. A handle part 11c is integrated with a top part side of the cylinder case part 11a along the motor case part 11b. A coupling part 11d is integrally provided between a tip part of the handle part 11c and a tip part of the motor case part 11b. In this manner, the housing 11 includes the cylinder case part 11a, the motor case part 11b, the handle part 11c, and the coupling part 11d. The housing 11 has two housing half body each of which is formed of a resin such as nylon or polycarbonate. The housing 11 is assembled by coming face to face with the two housing half bodies.

The cylinder 12 is housed in the cylinder case part 11a. A piston 13 is provided in a cylinder hole 12a so as to be allowed to reciprocate in an axial direction thereof. In a case where in FIG. 1 a top end part the cylinder 12 is referred to as a top part and a bottom end part of the cylinder 12 is referred to as a tip part, the piston 13 reciprocates between the tip part and the top part of the cylinder 12. A piston chamber 14 is defined by the cylinder hole 12a and a top surface of the piston 13. A driver blade 15 is coupled to the piston 13, and the driver blade 15 is supported in an injection port 17 of a nose part 16 provided on the housing 11 so that the driver blade 15 can freely reciprocate in an axial direction thereof. A magazine 18 that houses a large number of fasteners therein is mounted on the housing 11. The fasteners in the magazine 18 are supplied to the injection port 17 one by one. The fastener supplied to the injection port 17 is driven into a member to be driven, such as lumber or a gypsum board, by the driver blade 15 coupled to the piston 13. When a driving operation is carried out, an operator grips the handle part 11c, and operates the fastener driving machine 10 while causing the cylinder 12 to face to the front.

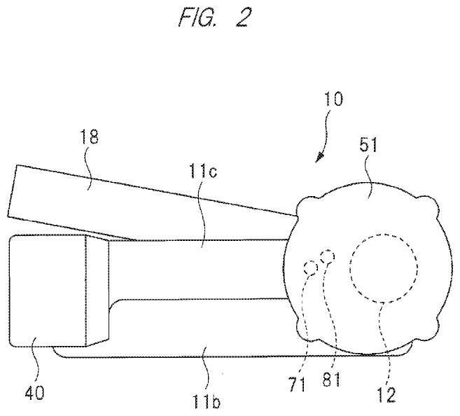

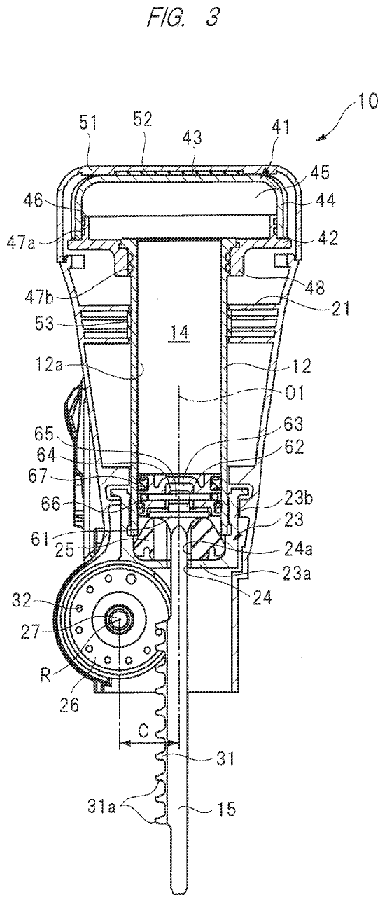

As shown in FIG. 2, the motor case part 11b is arranged so as to be shifted to one side in a width direction of the fastener driving machine 10 with respect to the handle part 11c, and the magazine 18 is arranged so as to be tilted at the opposite side in the width direction thereof with respect to the motor case part 11b. As shown in FIG. 1, the magazine 18 is tilted downward from a rear end part to the tip part. However, the magazine 18 may be arranged at a right angle relative to the cylinder 12.

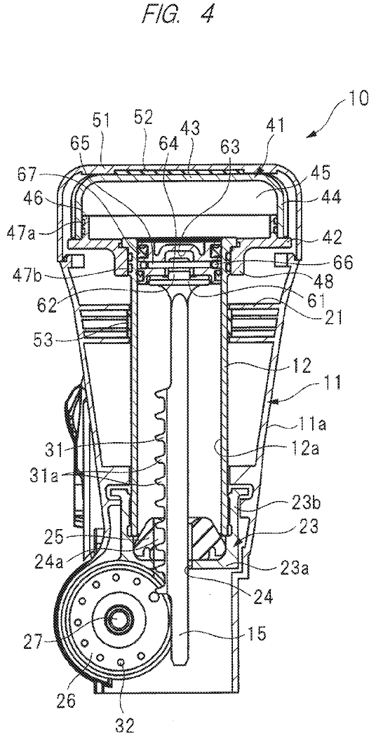

A protruding portion 21 and a protruding portion 22 are provided in the cylinder case part 11a. The protruding portion 21 abuts on an outer peripheral surface of the cylinder 12 at the top part side thereof. The protruding portion 22 abuts on the outer peripheral surface of the cylinder 12 at the tip part side. The cylinder 12 is fixed in the cylinder case part 11a by means of the protruding portions 21, 22. As shown in FIG. 3 and FIG. 4, a holder 23 provided with an end wall part 23a and a cylindrical part 23b is mounted on the tip part of the cylinder 12. The driver blade 15 penetrates a through hole 24 provided in the end wall part 23a.

FIG. 1 and FIG. 3 show a state where the driver blade 15 is driven by the piston 13 to become a forward limit position (bottom dead point). FIG. 4 shows a state where the piston 13 becomes a backward limit position (top dead point) by means of the driver blade 15. In order to absorb an impact of the piston 13 when the piston 13 is driven to the tip part of the cylinder 12, a damper 25 made of rubber or urethane is provided in the holder 23. The driver blade 15 penetrates a through hole 24a provided in the damper 25.

In order to return the piston 13 to backward limit position shown in FIG. 4, a rotary disk 26 is provided in the motor case part 11b. The rotary disk 26 is provided on a drive shaft 27. As shown in FIG. 1, the drive shaft 27 is rotatably supported by bearings 28a, 28b mounted in the motor case part 11b. A rack 31 provided with a plurality of rack claws 31a is mounted on the driver blade 15, and a plurality of pins 32 that engages with the rack claws 31a is mounted on the rotary disk 26 in a circumferential direction at predetermined intervals. As shown in FIG. 1 and FIG. 3, a rotation central shaft R of the rotary disk 26 is shifted by a distance C in a radial direction of the cylinder 12 with respect to a central axis O1 of the cylinder 12, and the rotation central shaft R becomes substantially a right angle relative to the central axis O1. FIG. 1 shows a section of a portion of the rotation central shaft R and a section of a portion of the central axis O1.

In order to rotationally drive the rotary disk 26, an electric motor 33 is fitted to the inside of the motor case part 11b, the electric motor 33 has a stator 33a and a rotor 33b. The stator 33a is fixed to the motor case part 11b. The rotor 33b is rotatably provided in the stator 33a. A cooling fan 35 is mounted on a motor shaft 34 provided on the rotor 33b. A cooling air for cooling the electric motor 33 is generated in the housing 11 by the cooling fan 35. An air intake hole (not shown in the drawings) through which the outside air is introduced and a discharge hole (not shown in the drawings) through which the air after cooling the motor is discharged are provided in the housing 11.

A planetary gear type speed reducer 36 is fitted to the inside of the motor case part 11b. An input shaft 37a of the speed reducer 36 is coupled to the motor shaft 34, and an output shaft 37b of the speed reducer 36 is coupled to the drive shaft 27. A base end part of the motor shaft 34 is rotatably supported by a bearing 38a mounted on the motor case part 11b, and the input shaft 37a to which a tip part of the motor shaft 34 is coupled is rotatably supported by a bearing 38b that is mounted on a speed reducer holder 39.

A battery 40 for supplying an electric power to the electric motor 33 is detachably fitted to a rear end part of the housing 11. The battery 40 has a housing case 40a and a plurality of battery cells (not shown in the drawings) that is housed in the housing case 40a. Each of the battery cells is a secondary battery that is composed of a lithium-ion battery, a nickel metal hydride battery, a lithium ion polymer battery, nickel-cadmium battery or the like.

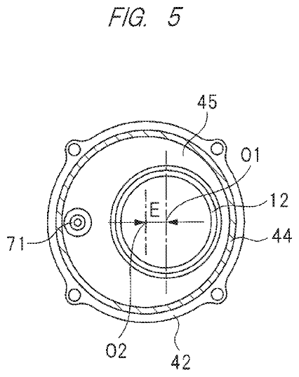

A pressure accumulating container 41 is provided on the cylinder 12 outside the cylinder 12 in the axial direction thereof. The pressure accumulating container 41 has a bottom wall portion 42 that is mounted on the top part of the cylinder 12 and extends outward in the radial direction of the cylinder 12. A cylindrical part 44 with which a top wall portion 43 is integrated is mounted on the bottom wall portion 42, and the top wall portion 43 faces the top part of the cylinder 12 and the bottom wall portion 42. A compression chamber 45 that communicates with the piston chamber 14 is formed inside the pressure accumulating container 41. As shown in FIG. 5, the bottom wall portion 42 is formed by a member whose outer peripheral surface is a round shape. A center O2 of the bottom wall portion 42 is eccentrically provided by an amount of eccentricity E from the central axis O1 of the cylinder 12 toward the handle part 11c, and the bottom wall portion 42 is shifted in the radial direction with respect to the cylinder 12. Therefore, the compression chamber 45 of the pressure accumulating container 41 is eccentrically provided with respect to the central axis O1 of the cylinder 12.

The pressure accumulating container 41 has the cylindrical part 44 whose diameter is larger than that of the cylinder 12. Thus, it is possible to shorten a length in a vertical direction containing the cylinder 12 and the pressure accumulating container 41 compared with a case where the compression chamber 45 is formed at the top part side of the cylinder 12. This makes it possible to downsize the fastener driving machine 10.

An annular projecting part 46 to which the cylindrical part 44 is fitted is provided on an inner surface of the bottom wall portion 42, and a space between the projecting part 46 and the cylindrical part 44 is sealed by a sealing member 47a. An annular projecting part 48 to which the cylinder 12 is fitted is provided on an outer surface of the bottom wall portion 42. A space between the projecting part 48 and the cylinder 12 is sealed by a sealing member 47b. The pressure accumulating container 41 is covered by a cover 51 mounted in the cylinder case part 11a. A sheet-like vibration isolation rubber 52 is assembled between the cover 51 and the pressure accumulating container 41. Moreover, an annular vibration isolation rubber 53 is assembled between the protruding portion 21 and the cylinder 12.

The inside of the piston chamber 14 and the compression chamber 45 is filled with an air as a gas. As shown in FIG. 1, in order to drive the piston 13, which becomes the tip part of the cylinder 12, toward the top part, the rotary disk 26 is rotationally driven in a counterclockwise direction in FIG. 3 via the speed reducer 36 by means of the electric motor 33. When the rotary disk 26 is rotated, the pins 32 provided downstream in a rotational direction in turn engage with the rack claws 31a shown at a lower side in FIG. 3. When it becomes a state where the pin 32 provided at the most downstream side in the rotational direction engages with the lowermost rack claw 31a, as shown in FIG. 4, the piston 13 is driven almost to an opening of the top part of the cylinder 12. In this state, the compressed air within the piston chamber 14 gets into the compression chamber 45, and a pressure of the compressed air in the compression chamber 45 becomes almost the maximum. When the rotary disk 26 is rotationally driven continuously and engagement of the pin 32 and rack claw 31a is released, the piston 13 is driven toward the tip part from the top part of the cylinder 12 by means of the pressure of the compressed air in the compression chamber 45. A rotation angle of the rotary disk 26 is detected by an angle detecting sensor (not shown in the drawings).

A push rod (contact arm) 54 is provided on the nose part 16 so that the push rod 54 can freely reciprocate in an axial direction thereof. The push rod 54 is biased by spring force of a helical compression spring 55 in a direction to which the tip part projects. When the push rod 54 is caused to abut on the member to be driven and the push rod 54 moves backward against the spring force, a press detecting sensor (not shown in the drawings) is activated. A trigger 56 is provided on the handle part 11c. When the trigger 56 is operated, a trigger switch 57 is activated.

A controller 58 is provided in the housing 11. Detected signals are sent to the controller 58 from the angle detecting sensor, the press detecting sensor, and the trigger switch 57 described above. As shown in FIG. 1 and FIG. 3, when the trigger 56 is operated at the forward limit position in which the piston 13 becomes the tip part of the cylinder 12 and the push rod 54 is caused to abut on the member to be driven to turn on the trigger switch 57, the electric motor 33 is driven. This causes the rotary disk 26 to be rotationally driven, and the piston 13 is driven to a position of the top part of the cylinder 12. When the engagement of the pin 32 and the rack claw 31a is released, the piston 13 is driven to the forward limit position by means of the compressed air in the compression chamber 45, and the fastener is driven to the member to be driven by means of the driver blade 15.

As shown in FIG. 3 and FIG. 4, a flange 61 that abuts on the damper 25 is provided at a base end part of the driver blade 15, and a coupling part 62 projects upward from the flange 61. The coupling part 62 gets into a concave part 63 formed in the piston 13. A long hole 64 extending in a direction of the central axis O1 is provided in the coupling part 62. A piston pin 65 that penetrates the long hole 64 is fitted to the piston 13, and the long hole 64 is larger than a diameter of the piston pin 65. A snap ring 66 that becomes a locking member is fitted to the piston 13, and the snap ring 66 abuts on both end parts of the piston pin 65. A sealing member 67 that seals a space between the piston 13 and the cylinder hole 12a is fitted to an outer circumferential part of the piston 13.

In this manner, since the driver blade 15 is mounted on the piston 13 by means of the piston pin 65 that penetrates the long hole 64, the driver blade 15 is configured to be swingable in a radial direction of the piston 13 with respect to the piston 13. Even though the driver blade 15 swings when the piston 13 is driven toward the top part of the cylinder 12 via the driver blade 15 by means of the rotary disk 26, it is possible to prevent an external force in the radial direction from being applied to the piston 13. This makes it possible to smoothly drive the piston 13 by means of the rotary disk 26.

In order to fill the inside of the compression chamber 45 with the compressed air, as shown in FIG. 1, a filling valve 71 is provided on the bottom wall portion 42 of the pressure accumulating container 41. The filling valve 71 is fixed to the bottom wall portion 42 at a base end part thereof by means of a nut 72, and a tip part thereof projects to downward of the bottom wall portion 42, that is, toward the cylinder 12 side. A joint part 73 is provided at the tip part of the filling valve 71. When the compression chamber 45 is filled with the compressed air, a supply port of any of various kinds of compressed gas supplying means, such as a compressor, an air feeder, and a compressed gas cylinder, is connected to the joint part 73. A check valve is assembled inside the filling valve 71. When the supply port of compressed air supplying means is connected to the joint part 73, the check valve is opened, and a compressed gas such as a compressed air is filled in the compression chamber 45. When the supply port is removed from the joint part 73, the filling valve 71 is closed by the check valve.

In order to connect the supply port to the joint part 73 of the filling valve 71, an opening (not shown in the drawings) is provided in the housing 11. When the fastener driving machine 10 is assembled, the compressed air is supplied to the compression chamber 45 by means of the compressed air supplying means by using the filling valve 71. Moreover, in a case where a gas pressure within the compression chamber 45 decreases, the compressed air is supplied to the compression chamber 45 by pressure supplying means. On the other hand, when the cylinder 12 is taken out from the inside of the housing 11, the check valve assembled in the filling valve 71 is operated by means of an operation jig, whereby a gas within the compression chamber 45 is discharged to the outside. Further, a relief valve 81 may be operated similarly to discharge the gas within the compression chamber 45 to the outside.

In order to discharge the compressed air within the compression chamber 45 to the outside in a case where a pressure in the compression chamber 45 exceeds a setting value, the relief valve 81 is provided on the bottom wall portion 42. The setting value is set to a pressure of the compression chamber 45 that is required to drive a fastener with the maximum length, which is to be driven by the fastener driving machine 10.

As shown in FIG. 1 and FIG. 2, the filling valve 71 and the relief valve 81 are provided on the bottom wall portion 42 that projects outward in the radial direction of the cylinder 12. For this reason, a room formed under the bottom wall portion 42, that is, at the cylinder 12 side (hereinafter, referred to as a “space”) is utilized, and the filling valve 71 and the relief valve 81 are disposed in the space. This makes it possible to suppress a diameter of the cylinder case part 11a from being made larger in size. In particular, as shown in FIG. 1 and FIG. 2, in a case where the filling valve 71 and the relief valve 81 are disposed in a space between the handle part 11c and the cylinder 12, the pressure accumulating container 41 is arranged so as to be shifted to the handle part 11c side of the cylinder 12 with respect to the central axis O1. Therefore, by effectively utilizing the space under the compression chamber 45, it is possible to dispose the filling valve 71 and the relief valve 81.

As described above, since the filling valve 71 is disposed in the space between the handle part 11c and the cylinder 12, it is possible to carry out filling up of the compressed air to the compression chamber 45 easily by using the filling valve 71. Moreover, the relief valve 81 is disposed in the same space for the filling valve 71. In a case where the air (gas) containing oil content and/or moisture content is discharged from the relief valve 81 to the inside of the cylinder case part 11a of the housing 11, it is possible to prevent the air from directly blowing against electrical parts or electronic parts.

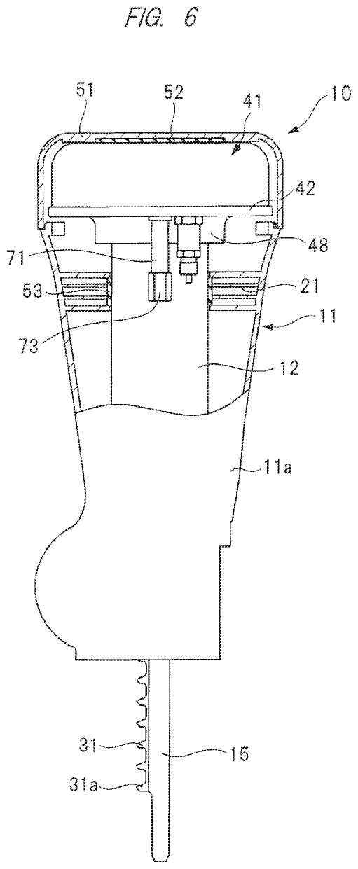

FIG. 6 is a partial cutaway front view showing a fastener driving machine 10 according to a modified example. In FIG. 6, a filling valve 71 and a relief valve 81 are positioned at a front side of a cylinder 12 and mounted on a bottom wall portion 42. Namely, in the case shown in FIG. 1, the filling valve 71 and the relief valve 81 are disposed between the cylinder 12 and the cylinder case part 11a at a back side of the cylinder 12. On the other hand, in the fastener driving machine 10 shown in FIG. 6, the filling valve 71 and the relief valve 81 are disposed at the opposite side to the case shown in FIG. 1 by using the cylinder 12 as an intermediary. In this manner, even in the form where the filling valve 71 and the relief valve 81 are positioned at the front side of the cylinder 12 and are mounted on the bottom wall portion 42 of a pressure accumulating container 41, it is possible to cause the filling valve 71 and the relief valve 81 to project downward by using the bottom wall portion 42 of the pressure accumulating container 41, whose diameter is larger than that of the cylinder 12.

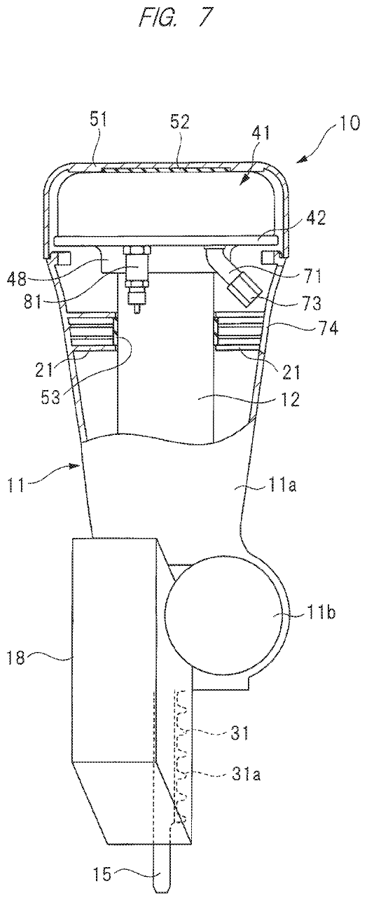

FIG. 7 is a partial cutaway back view of the fastener driving machine 10 according to another modified example when viewed from a magazine side. In the fastener driving machine 10, as well as the fastener driving machine shown in FIG. 1, a filling valve 71 and a relief valve 81 is provided in a space between a cylinder 12 and a cylinder case part 11a. The filling valve 71 described above is mounted on the bottom wall portion 42 approximately at a right angle, whereas the filling valve 71 shown in FIG. 7 is tilted toward an inner surface of a housing 11. Thus, a joint part 73 provided at a tip part of the filling valve 71 approaches the inner surface of the housing 11. By adopting a tilted structure for the filling valve 71 in this manner, it is possible to connect a supply port of compressed gas supplying means to the joint part 73 easily. In order to connect the supply port to the joint part 73 of the filling valve 71, an opening 74 is provided in the housing 11.

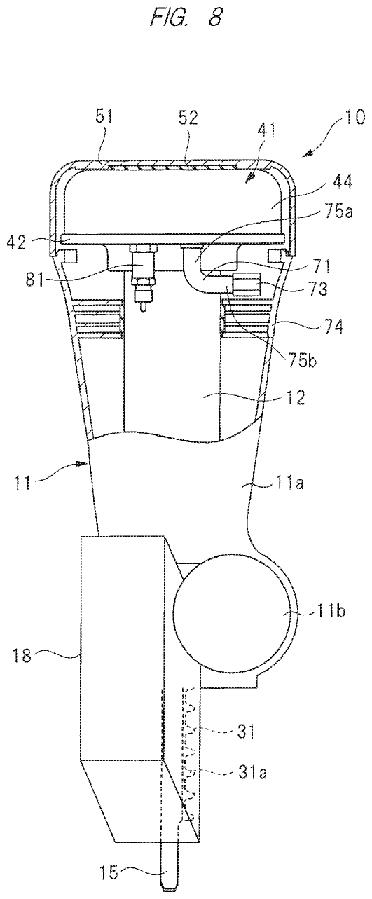

FIG. 8 is a partial cutaway back view of a fastener driving machine 10 according to still another modified example when viewed from the magazine side. A filling valve 71 shown in FIG. 8 has a base part 75a and a tip part 75b. The base part 75a is mounted on a bottom wall portion 42 to become a right angle relative to the bottom wall portion 42. The tip part 75b is bent approximately at a right angle relative to the base part 75a to be inflected toward a housing 11. A joint part 73 is provided on the tip part 75b. By adopting a bent structure for the filling valve 71 in this manner, it is also possible to connect a supply port of compressed gas supplying means to the joint part 73 easily. The supply port is connected to the joint part 73 of the filling valve 71 through an opening 74.

FIG. 7 and FIG. 8 show the case where the filling valve 71 and the relief valve 81 are disposed at the back side of the cylinder 12, that is, in the space between the cylinder 12 and the handle part 11c. However, even in a case where they are disposed at the front side of the cylinder 12 as shown in FIG. 6, it is possible to adopt the tilted structure or the bent structure for the filling valve 71.

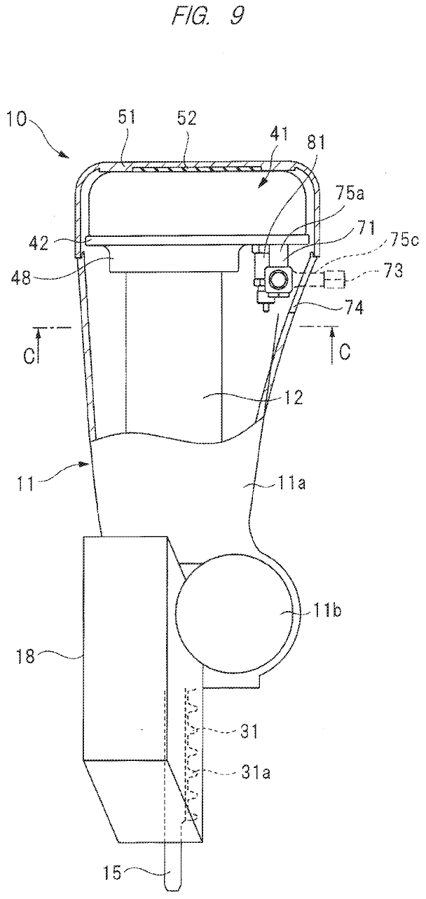

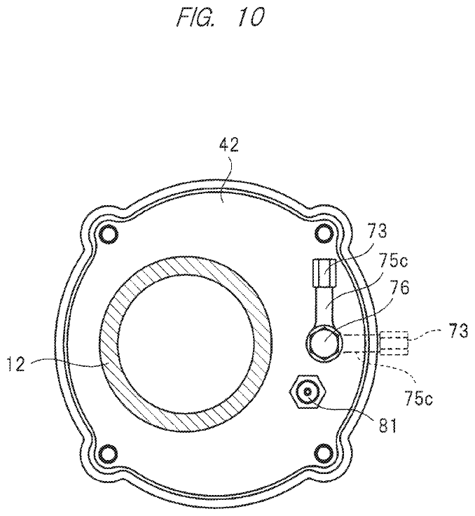

FIG. 9 is a partial cutaway back view of a fastener driving machine 10 according to still another modified example when viewed from a magazine side. FIG. 10 is a sectional view taken along a C-C line of FIG. 9. In the fastener driving machine 10 shown in FIG. 9, a pressure accumulating container 41 is shifted to a right side in FIG. 9, that is, to a right side when viewed from the front, and a filling valve 71 and a relief valve 81 are fitted to a bottom wall portion 42 of the pressure accumulating container 41, which is shifted laterally with respect to a cylinder 12. The filling valve 71 has a base part 75a and a rotary part 75c. The base part 75a is mounted on the bottom wall portion 42 to become a right angle relative to the bottom wall portion 42. The rotary part 75c is rotatably coupled to the base part 75a via a rotary joint 76. The rotary part 75c is bent in a direction substantially perpendicular to the base part 75a. When a joint part 73 provided on the rotary part 75c is rotated, the rotary part 75c projects from an opening 74 as shown with a broken line in FIG. 10. By adopting a rotary type for the filling valve 71 in this manner, it is possible to connect a supply port of compressed gas supplying means to the joint part 73 easily.

In a case where the filling valve 71 and the relief valve 81 are disposed at the right side in FIG. 9, that is, at a motor case part 11b side, they are caused not to protrude laterally from the motor case part 11b. The filling valve 71 and the relief valve 81 may be disposed at the opposite side to the case of FIG. 9, that is, at a magazine 18 side. In such a case, the filling valve 71 and the relief valve 81 are also caused not to protrude laterally from the magazine 18. In a case where the filling valve 71 and the relief valve 81 are disposed at any side of the right and left sides of the pressure accumulating container 41 in this manner, it is possible cause a handle part 11c to approach the cylinder 12. This makes it possible to improve operability of the fastener driving machine 10. Further, the filling valve 71 and the relief valve 81, which have the structure shown in FIG. 9, may be disposed at the position shown in FIG. 1.

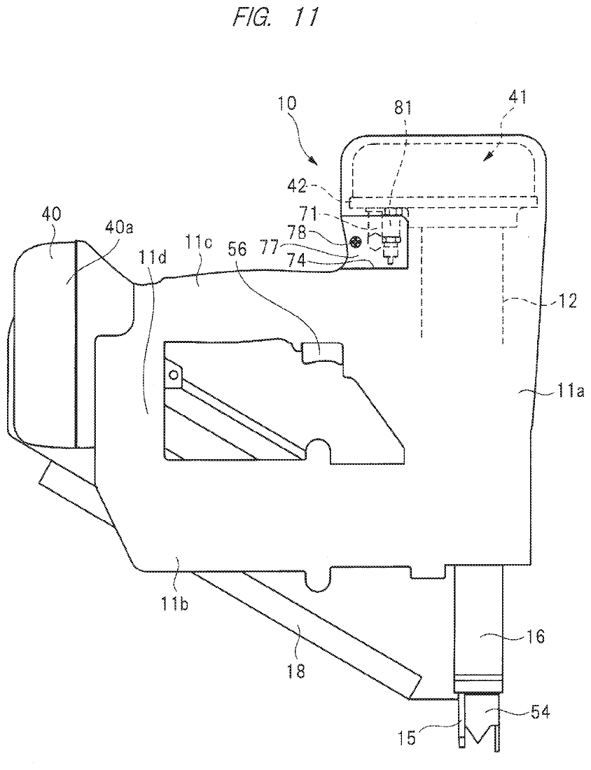

FIG. 11 is aside view of the fastener driving machine in which a lid member provided in a housing is shown. An opening 74 is provided at a portion facing a filling valve 71 on a cylinder case part 11a of a housing 11. A lid member 77 is detachably provided on the opening 74. The lid member 77 is fixed to the housing 11 by means of a screw member 78. When the screw member 78 is loosened and the lid member 77 is detached, the filling valve 71 and a relief valve 81 are exposed to the outside. In an exposed state, a supply port of compressed gas supplying means is connected to a joint part 73 of the filling valve 71.

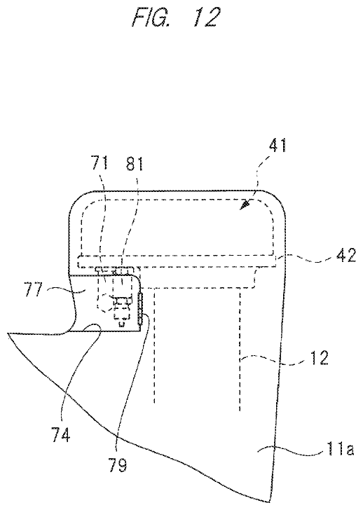

FIG. 12 is a side view showing a part of the fastener driving machine in which a lid member according to a modified example is provided. A lid member 77 shown in FIG. 12 is provided in a housing 11 so that the lid member 77 can be opened and closed by a hinge part 79. In this manner, an opening and closing system of the lid member 77 may be a detachable type as shown in FIG. 11 or an opening/closing type. FIG. 11 and FIG. 12 show the case where the filling valve 71 and the relief valve 81 are disposed in a space at a back surface side of a cylinder 12 between the cylinder 12 and a handle part 11c as shown in FIG. 1. However, the lid member 77 can similarly be provided in a case where they are disposed in a space at a front surface side of the cylinder 12 as shown in FIG. 6 to FIG. 8, or in a case where they are disposed in a space at a side surface of the cylinder 12 as shown in FIG. 9.

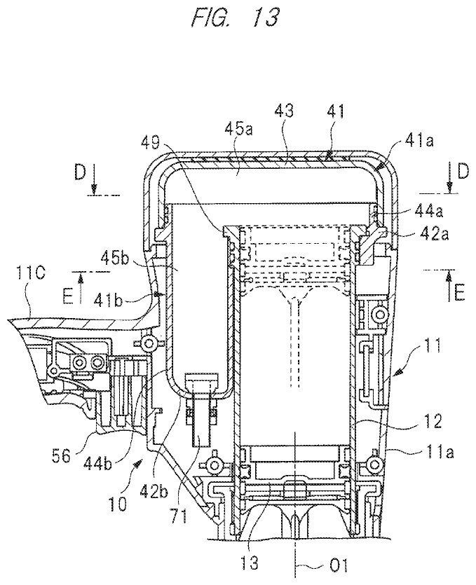

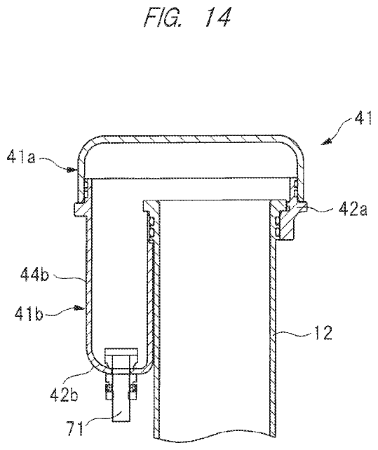

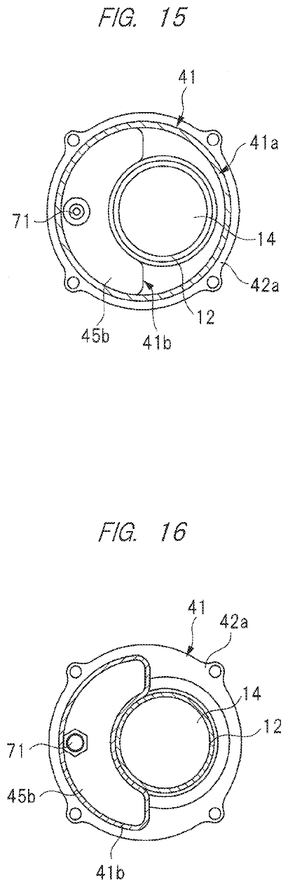

FIG. 13 is a sectional view of a side surface showing a main part of a fastener driving machine 10 according to another embodiment. FIG. 14 is an enlarged sectional view showing a pressure accumulating container shown in FIG. 13. FIG. 15 is a sectional view taken along a D-D line of FIG. 13. FIG. 16 is a sectional view taken along an E-E line of FIG. 13. A portion in FIG. 13 whose illustration is omitted is similar to that in the fastener driving machine 10 shown in FIG. 1.

In the fastener driving machine 10 shown in FIG. 13, as shown in FIG. 14, a pressure accumulating container 41 has a first pressure accumulating container 41a and a second pressure accumulating container 41b. The first pressure accumulating container 41a is provided outward in an axial direction of a cylinder 12, and has a first bottom wall portion 42a mounted on a top part of the cylinder 12. In the pressure accumulating container 41a, a cylindrical part 44a that is integrated with a top wall portion 43 is mounted on the bottom wall portion 42a, and the top wall portion 43 faces the top part of the cylinder 12 and the bottom wall portion 42a. A first a compression chamber 45a that communicates with a piston chamber 14 is formed inside the first pressure accumulating container 41a. In the similar manner to the bottom wall portion 42 of the pressure accumulating container 41 shown in FIG. 1, an outer peripheral surface of the bottom wall portion 42a is formed by a member having a round shape, and the bottom wall portion 42a is shifted in a radial direction toward a handle part 11c with respect to the cylinder 12. Therefore, the compression chamber 45a of the first pressure accumulating container 41a is eccentrically provided with respect to a central axis O1 of the cylinder 12.

The second pressure accumulating container 41b projects downward from the bottom wall portion 42a along the cylinder 12 by using an opening 49 formed at the first bottom wall portion 42a as a base end part. A second compression chamber 45b in the pressure accumulating container 41b extends along the cylinder 12. The second pressure accumulating container 41b has a second bottom wall portion 42b and a second cylindrical part 44b. The second bottom wall portion 42b extends to the outward of the cylinder 12 so as to face the opening 49. The second cylindrical part 44b is integrally formed with the second bottom wall portion 42b. The second compression chamber 45b communicates with the piston chamber 14 via the first the compression chamber 45 a. As shown in FIG. 14 and FIG. 15, a transverse section of the second compression chamber 45b becomes an arc shape so as to partially enclose the cylinder 12.

By shifting the second pressure accumulating container 41b in the radial direction thereof with respect to the first pressure accumulating container 41a and arranging the second pressure accumulating container 41b in the reverse direction in this manner, it is possible to increase a volume of the compressed air to be accumulated by means of both of the compression chambers 45a, 45b compared with the case shown in FIG. 1.

As shown in FIG. 13, the filling valve 71 is provided on the second bottom wall portion 42b so as to project downward. In this case, by utilizing a space between the cylinder 12 and the handle part 11c, it is possible to dispose the filling valve 71 at a position shifted in the radial direction with respect to the cylinder 12.

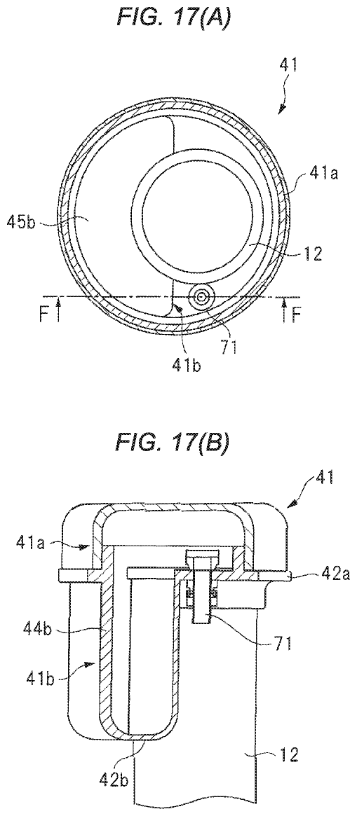

FIG. 17(A) is a plan view showing another modified example of the pressure accumulating container shown in FIG. 13, and FIG. 17(B) is a sectional view taken along an F-F line of FIG. 17(A).

As well as the case shown in FIG. 13, a pressure accumulating container 41 has a first pressure accumulating container 41a and a second pressure accumulating container 41b. A filling valve 71 is provided on a first bottom wall portion 42a unlike the case shown in FIG. 13. The filling valve 71 is provided on the bottom wall portion 42a so as to be shifted to a side surface of the fastener driving machine 10, that is, at a lower side in FIG. 17(A). Since the filling valve 71 is disposed in this manner, it is possible to use a gap between the pressure accumulating container 41b and a housing 11 effectively. This makes it possible to downsize the fastener driving machine 10. However, the filling valve 71 may be provided so as to be shifted at an upper side in FIG. 17(A). Alternatively, the filling valve 71 may be provided on the bottom wall portion 42a so as to be shifted to a front surface side of the fastener driving machine 10.

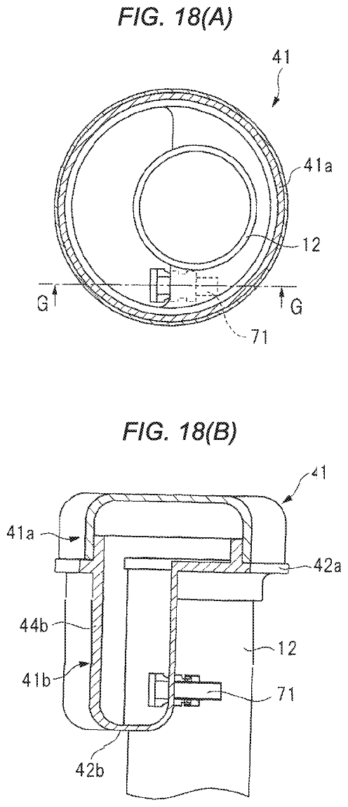

FIG. 18(A) is a plan view showing still another modified example of the pressure accumulating container shown in FIG. 13. FIG. 18(B) is a sectional view taken along a G-G line of FIG. 18(A). In a fastener driving machine 10, a filling valve 71 is disposed on a cylindrical part 44b of a second pressure accumulating container 41b, that is, on a side wall. In a case where the filling valve is disposed on the side wall of the pressure accumulating container 41b in this manner, it is possible to utilize a gap between the pressure accumulating container 41b and a housing 11, and this makes it possible to downsize the fastener driving machine 10.

Moreover, in the embodiment described above, the case where the present invention is applied to a DC motor (DC inverter motor) using a battery as a power source has been described. However, the present invention is not limited to this, and the present invention may be applied to a motor (AC inverter motor) using an AC power source. Further, an AC-DC converter may be used in place of the battery. An electric power may be supplied to a DC motor (DC inverter motor) in the fastener driving machine by converting a commercial power supply (AC power supply) into a DC power supply.

The present invention is not limited to the embodiments, and various modifications can be made without departing from the substance thereof.

### EXPLANATION OF REFERENCE NUMERALS

10 . . . fastener driving machine, 11 . . . housing, 11a . . . cylinder case part, 11b . . . motor case part, 11c . . . handle part, 12 . . . cylinder, 13 . . . piston, 14 . . . piston chamber, 15 . . . driver blade, 16 . . . nose part, 17 . . . injection port, 18 . . . magazine, 23 . . . holder, 24, 24a . . . through hole, 25 . . . damper, 26 . . . rotary disk, 27 . . . drive shaft, 31 . . . rack, 31a . . . rack claw, 32 . . . pin, 33 . . . electric motor, 34 . . . motor shaft, 35 . . . cooling fan, 36 . . . speed reducer, 39 . . . speed reducer holder, 40 . . . battery, 41 . . . pressure accumulating container, 41a . . . first pressure accumulating container, 41b . . . second pressure accumulating container, 42 . . . bottom wall portion, 42a . . . first bottom wall portion, 42b . . . second bottom wall portion, 43 . . . top wall portion, 44 . . . cylindrical part, 44a . . . first cylindrical part, 44b . . . second cylindrical part, 45 . . . compression chamber, 45a . . . first compression chamber, 45b . . . second compression chamber, 48 . . . projecting part, 49 . . . opening, 51 . . . cover, 54 . . . push rod, 55 . . . helical compression spring, 56 . . . trigger, 57 . . . trigger switch, 58 . . . controller, 61 . . . flange, 62 . . . coupling part, 63 . . . concave part, 64 . . . long hole, 65 . . . piston pin, 66 . . . snap ring, 67 . . . sealing member, 71 . . . filling valve, 72 . . . nut, 73 . . . joint part, 74 . . . opening, 75a . . . base part, 75b . . . tip part, 75c . . . rotary part, 76 . . . rotary joint, 77 . . . lid member, 78 . . . screw member, 79 . . . hinge part, 81 . . . relief valve

1. A fastener driving machine comprising:
a piston;
a cylinder in which the piston moves in a first direction and a second direction opposite to the first direction;
a pressure accumulating container being configured to be filled with a gas to provide the cylinder with a driving force to move the piston in the first direction;
a driver blade coupled to the piston to apply the driving force of the piston to a fastener;
a housing having a handle, the housing covering the cylinder and the pressure accumulating container; and
a rotary component configured to engage with the driver blade to move the driver blade and the piston in the second direction;
a valve disposed in an opening of the housing, and configured to control a flow of the gas for the pressure accumulating container; and
a removable or hinged lid for covering the opening of the housing.

2. The fastener driving machine according to claim 1,
wherein the valve is a filling valve configured to allow the gas to flow into the pressure accumulating container, and
wherein the filling valve becomes visible externally when the opening is uncovered by the lid.

3. The fastener driving machine according to claim 2, wherein the filling valve has a joint connectable to a gas supply.

4. The fastener driving machine according to claim 1,
wherein the valve is a relief valve configured to allow the gas to be discharged from the pressure accumulating container, and
wherein the relief valve becomes visible externally when the opening is uncovered by the lid.

5. The fastener driving machine according to claim 1, wherein the lid is fixed to the housing by a screw to cover the opening of the housing.

6. The fastener driving machine according to claim 1,
wherein the housing comprises a first part and a second part,
wherein the handle comprise a third part formed on the first part, and a fourth part formed on the second part, and
wherein the first part and the second part are coupled together to form the housing by which the third part and the fourth part are coupled together to form the handle.

7. The fastener driving machine according to claim 6, wherein even when the opening of the housing is uncovered by the lid, (1) the first part and the second part are maintained to be coupled together to form the housing and (2) the third part and the fourth part are maintained to be coupled together to form the handle.
